(19) United States
(12) Patent Application Publication
(10) Pub. No.: US 2024/0377674 A1
(43) Pub. Date: Nov. 14, 2024

(54) DISPLAY ELEMENT HAVING CAMOUFLAGE TECHNOLOGY

(71) Applicant: Continental Automotive Technologies GmbH, Hannover (DE)

(72) Inventors: Kai Hohmann, Babenhausen (DE); Jürgen Bäthis, Wetzlar (DE); Andreas Brüninghaus, Wiehl (DE)

(73) Assignee: Continental Automotive Technologies GmbH, Hannover (DE)

(21) Appl. No.: 18/693,057

(22) PCT Filed: Sep. 14, 2022
(86) PCT No.: PCT/DE2022/200217

§ 371 Date: Mar. 18, 2024

(30) Foreign Application Priority Data
Sep. 20, 2021 (DE) 10 2021 210 408.8

(51) Int. Cl. G02F 1/1333; G02F 1/1335

(52) U.S. Cl. CPC G02F 1/13338; G02F 1/133314; G02F 1/133331; G02F 1/133512; G02F 1/133562; G02F 2202/28

(57) ABSTRACT

The present disclosure relates to a display element with disappearance technology and to a method for producing such a display element. The display element has a display panel, a backlight arranged behind the display panel, and a surface shield. A decoration is arranged on a top side of the surface shield. In this case, a distance between light valves of the display panel and a surface of the decoration is less than 3 mm, preferably less than 2 mm.

### CROSS REFERENCE TO RELATED APPLICATIONS

This US patent application claims the benefit of PCT patent application No. PCT/DE2022/20017, filed Sep. 14, 2022, which claims the benefit of German patent application No. 10 2021 210 408.8, filed Sep. 20, 2021, both of which are hereby incorporated by reference.

### TECHNICAL FIELD

The present disclosure relates to a display element with disappearance technology and to a method for producing such a display element.

### BACKGROUND

Non-self-luminous transmissive display elements such as LCDs (liquid crystal displays) require a backlight for image representation. The task of the backlight is here to illuminate the display element as uniformly as possible over the entire active surface in order to produce a display that is as homogeneous as possible right up to the peripheral region. A display that is as bright as possible is achieved due to the fact that the alignment of a liquid crystal layer of the display element in combination with the alignment of polarizing filters permits maximum transmission. A dark or black display content, e.g. in the peripheral region, is achieved by way of minimal transmission, which, in contrast to self-luminous displays, is here always greater than zero.

In the automotive sector, but also in household appliances and in other areas of application, there is an observable trend that operating or display functions should be as invisible as possible in the switched-off state in order to achieve a reduced design with smooth, generous surfaces. Technical elements should be visible only when they are needed. Such disappearance technologies are known, for example, under the names “Shytech” or “Camouflage.”

To realize disappearance technology, for example, a display element may be arranged behind a design surface. Suitable transmissive, decorative surfaces for this application may be made in real material, e.g. wood, stone, leather, imitation leather, etc., and may also be manufactured in plastic or glass technology. The decoration is applied by printing technology onto the surface of a cover sheet or alternatively onto a separate foil surface. The decoration may be applied, for example, as a transmissive print or in the form of an aperture mask.

In this context, US 2015/0036061 A1 describes a display apparatus with a decorative layer, which is formed at least in part of a viewing region. When a display module of the display apparatus is in operation and emits light through the decorative layer, the decorative layer appears transparent. When the display module is not in operation, the decorative layer is irradiated by ambient light, and a decorative pattern of the decorative layer is visible.

WO 2021/085524 A1 describes a display apparatus for being attached to an object. The display apparatus comprises a display unit with a display surface for displaying video data, a translucent decorative layer, which is arranged on the side of the display surface and provides a decorative design that harmonizes with the external appearance of the object, and a translucent one-way mirror layer arranged between the display unit and the decorative layer.

When implementing the disappearance technology, a high-quality resolution of the display through the structure of the decoration should be achieved. In practice, however, the influence of a large number of parameters leads to impairments in image quality. In this regard, the surface properties of the decoration, the use of a surface shield made of plastic, which supports the decoration and requires a certain mechanical distance from the image-generating display surface, the mechanical stability of the surface or of the surface cover glass, and the assembly process of the display in relation to the surface may be mentioned. If necessary, a transparent touch sensor may also need to be integrated, which may likewise result in a degradation in image quality.

A further complicating point for an authentic material representation is that the decoration should be executed on the topmost surface facing the viewer in order to create a visually and haptically authentic overall experience.

In summary, displays with disappearance technology are considerably more difficult to design in terms of image quality and appearance than standard displays.

### SUMMARY

It is an object of the disclosure to provide a display element with disappearance technology which combines a realistic decoration with a high-quality appearance with regard to readability or image sharpness.

This object is achieved by a display element having the features of the claims and by a method as claimed in the claims for producing a display element. The dependent claims relate to configurations of the disclosure.

According to a first aspect of the disclosure, a display element has a display panel; a backlight arranged behind the display panel; a surface shield; and a decoration arranged on a top side of the surface shield; wherein a distance between light valves of the display panel and a surface of the decoration is less than 3 mm, preferably less than 2 mm.

In the solution according to the disclosure, a high-quality image display is ensured by the fact that the distance between the light exit from the display panel and the surface of the decoration is kept as small as possible. This can be achieved, firstly, by the surface shield being shaped onto the glass onto which the decoration is laminated as a film. The glass may also be curved or shaped. Laminating the film onto a three-dimensionally shaped glass is then for example carried out as areal pressing. However, if a more complexly shaped decorative part is intended to be configured as a display element with disappearance technology, then with glass this is possible only to a limited extent or at great expense. Therefore, the surface shield may alternatively be shaped as a plastic part using film technology, for example by means of an injection molding process. In a manner governed by the process, such a plastic part already requires a specific thickness in the production process. This thickness simultaneously ensures that the surface shield has a certain mechanical stability. However, the thickness of the surface shield may be problematic in regard to the optical or visual appearance. If the thickness is chosen such that the distance between the light exit from the display panel and the surface of the decoration does not exceed the values mentioned above, the effects on image sharpness may be sufficiently reduced, however. As an alternative to injection molding and in order to further reduce the thickness, the decorative film may also be laminated onto a thin carrier, e.g. a carrier composed of glass or a film composed of plastic with a thickness of 0.5 mm.

According to one aspect of the disclosure, a thickness of the surface shield in a display region located above the display panel is thinner than in a peripheral region extending around the display panel. This allows for further optimization of the image sharpness. The reduction of the thickness in the display region of a plastic shield may be effected e.g. directly in the plastic injection molding process, by adjusting the display region to be thinner on the basis of tooling engineering. The reduction of the thickness in the display region e.g. of a glass shield with a decorative surface film laminated thereon may be effected by partial and local slimming, e.g. etching. In this case, only the display region is exposed to the acid, whereas the peripheral region is masked off, for example.

According to one aspect of the disclosure, the display panel is connected to the surface shield by an optical bonding layer having a thickness of less than 0.5 mm, preferably less than 0.4 mm. The use of a very thin bonding layer having a defined thickness allows further reduction of the distance between the light exit from the display panel and the surface of the decoration. At the same time, the stability of the overall construction is increased and a constant distance between the surface of the display panel and the surface shield is attained. By way of example, an optical clear adhesive (OCA) film or a layer of a liquid optical clear adhesive (LOCA) may be used for the bonding layer. Deviations from the planarity of the bonding layer should preferably not exceed ±0.1 mm.

According to one aspect of the disclosure, a transmission of the decoration is less than 30%. This ensures that the decoration is perceived as authentic material representation when the display is switched off.

According to one aspect of the disclosure, a modular transfer function of the decoration is greater than 0.5. This ensures that the loss of contrast caused by the decoration remains within acceptable bounds.

According to one aspect of the disclosure, a resolution of the display panel is greater than 150 ppi, preferably greater than 200 ppi. A high pixel resolution is required for a high appearance of the display, i.e. for a high image quality. In this case, the decoration is preferably adapted to the resolution of the display panel. The adaptation may be effected e.g. in such a way that an aperture mask of the decoration is sufficiently small in relation to the pixels of the display panel and/or the aperture mask of the decoration is aligned in relation to the pixels. In order to reduce a moire effect, the aperture mask may be tilted in relation to the pixel structure of the display panel. Alternatively or additionally, the aperture mask may have an irregular distribution of the apertures for this purpose.

According to one aspect of the disclosure, a luminance of the backlight is greater than 2500 cd/m². The luminance of the backlight is thus increased by a factor of 2 to 5 in comparison with customary backlights. In combination with the transmission of the decoration of less than 30%, a luminance of the overall system of approximately 800 cd/m² is thus attained. The high luminance requires special measures with regard to heat dissipation, such as e.g. forced convection by a fan or the use of a housing produced by metal diecasting.

According to one aspect of the disclosure, the backlight is locally controllable. A so-called postcard effect, in which the peripheral region of the display shows through the overlying decoration, may be avoided in this way. The backlight is for example configured as a local dimming matrix backlight. In this case, the maximum size per illumination zone should be in the range of preferably 6 mm×6 mm to 20 mm×20 mm. The use of a local dimming matrix backlight is additionally advantageous with regard to the evolution of heat.

According to one aspect of the disclosure, the display panel has in-cell touch sensors. The touch function is integrated in the display panel and not implemented as a separate part. The additional contribution of the touch function to the overall thickness of the system is reduced in this way.

According to a further aspect of the disclosure, a method for producing a display element includes the steps of producing a surface shield with a decoration arranged on a top side of the surface shield; and connecting a display panel to the surface shield by an optical bonding layer having a thickness of less than 0.5 mm, preferably less than 0.4 mm.

In the method according to the disclosure, the display panel is connected to the surface shield by a very thin bonding layer having a defined thickness. The small thickness of the bonding layer makes it possible to reduce the distance between the light exit from the display panel and the surface of the decoration to less than 3 mm, preferably less than 2 mm. At the same time, a stable overall construction and a constant distance between the surface of the display panel and the surface shield are attained. By way of example, an optical clear adhesive film or a layer of a liquid optical clear adhesive may be used for the bonding layer. Deviations from the planarity of the bonding layer should preferably not exceed ±0.1 mm, since variations in the distance can lead to impairments of the image quality.

According to one aspect of the disclosure, a thickness of an upper cover glass of the display panel is reduced before the process of connecting the display panel to the surface shield. The upper cover glasses of display panels usually have a thickness of approximately 0.5 mm. The thickness may be reduced to approximately 0.15 mm by the use of slimming technologies, e.g. etching. This allows the light valves of the display panel to be brought close to the surface of the decoration. For stability reasons, it is expedient here if only the top side of the display panel is reduced in its thickness. This maintains the stiffness of the display panel to a certain extent.

According to one aspect of the disclosure, a transparent glass is laminated onto an underside of the display panel. This allows an increase in the stiffness of the overall system that has been reduced on account of slimming. On account of the lamination of the additional glass, it is expedient to provide a hard coat polarizer on the underside, i.e. a polarizing filter which has a smooth surface and therefore does not further scatter the light flooding through. It is additionally advantageous if the glass has an anti-glare structure on the underside in the direction of the backlight.

A display element according to the disclosure is used to implement a display with disappearance technology, for example in a transport or in a household appliance. The decoration may be used to simulate, for example, a wood look, a carbon look or an appearance of a metallic surface.

### BRIEF DESCRIPTION OF THE FIGURES

Further features of the present disclosure will become apparent from the following description and the appended claims in conjunction with the figures.

FIG. 1 schematically shows a display behind a decorative surface;

FIG. 2 schematically shows a first embodiment of a display element according to the disclosure;

FIG. 3 schematically shows a second embodiment of a display element according to the disclosure;

FIG. 4 schematically shows a third embodiment of a display element according to the disclosure; and

FIG. 5 schematically shows a method for producing a display element according to the disclosure.

### DETAILED DESCRIPTION

For a better understanding of the principles of the present disclosure, embodiments of the disclosure will be explained below in greater detail with reference to the figures. The same reference signs are used for identical or functionally identical elements in the figures and are not necessarily described again for each figure. It goes without saying that the disclosure is not restricted to the embodiments illustrated and that the features described may also be combined or modified without departing from the scope of protection of the disclosure as defined in the appended claims.

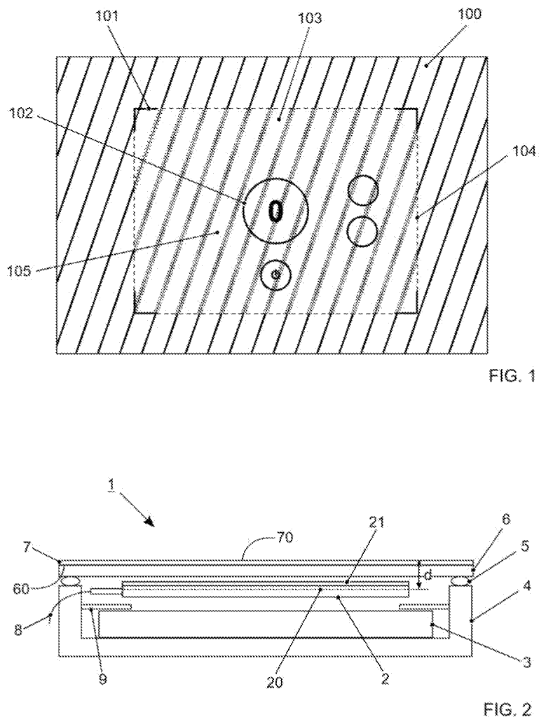

FIG. 1 schematically shows a display behind a decorative surface. It shows the effect of a known display element arranged behind a light-transmissive layer on a viewer. In the example shown, the light-transmissive layer is a decorative surface 100. The decorative design of the decorative surface 100 is indicated in FIG. 1 by hatching. The dimensions of the display element are indicated by corner elements 101. A plurality of symbols 102 are represented by the display element. Due to the properties of the decorative surface 100, of the display element and of the overall structure, the representation exhibits degradations in image quality, for example a high degree of diffusion. This is indicated in FIG. 1 by the dashed lines within the display region 103 that are drawn in addition to the hatching.

FIG. 2 schematically shows a first embodiment of a display element 1 according to the disclosure. The display element 1 has a housing 4, which is secured to a surface shield 6 by means of a securing element 5. Said surface shield is provided with a decoration 7 on its top side 60 facing away from the housing 4. An externally illuminated display panel 2, for example a liquid crystal display panel (LCD panel), is arranged on the inner side of the surface shield 6 facing the housing 4. In this case, a thickness of the surface shield 6 in a display region located above the display panel 2 can be thinner than in a peripheral region extending around the display panel 2. In this embodiment, there is an air gap between an upper cover glass 21 of the display panel 2 and the surface shield 6. The display panel 2 is connected via a control line 8 to a control unit (not shown here), which supplies it with energy and with image information to be represented. The display panel 2 is illuminated by a backlight 3 and has a plurality of light valves 20 that regulate the passage of light from the backlight 3 through the display panel 2. According to the disclosure, the distance d between the light valves 20 and a surface 70 of the decoration 7 is less than 3 mm, preferably less than 2 mm. Between the backlight 3 and the display panel 2, shields 9 that shield against stray light are arranged in a peripheral region. With regard to good heat dissipation, the housing 4 may be produced by metal diecasting.

For example, a transmission of the decoration 7 is less than 30%. This ensures that the decoration 7 is perceived as authentic material representation when the display is switched off. Moreover, a modulation transfer function of the declaration 7 should be greater than 0.5 in order that a loss of contrast caused by the decoration 7 remains within acceptable bounds.

A luminance of the backlight 3 is for example greater than 2500 cd/m². In combination with the transmission of the decoration 7 of less than 30%, a luminance of the overall system of approximately 800 cd/m² is thus attained. For example, the backlight 3 is locally controllable in this case. Moreover, a resolution of the display panel 2 is with preference greater than 150 ppi, preferably greater than 200 ppi. This high pixel resolution results in a high appearance of the display, i.e. a high image quality.

For example, the display panel 2 has in-cell touch sensors. By virtue of the touch function being integrated in the display panel and not implemented as a separate part, the additional contribution of a touch function to the overall thickness of the system may be reduced.

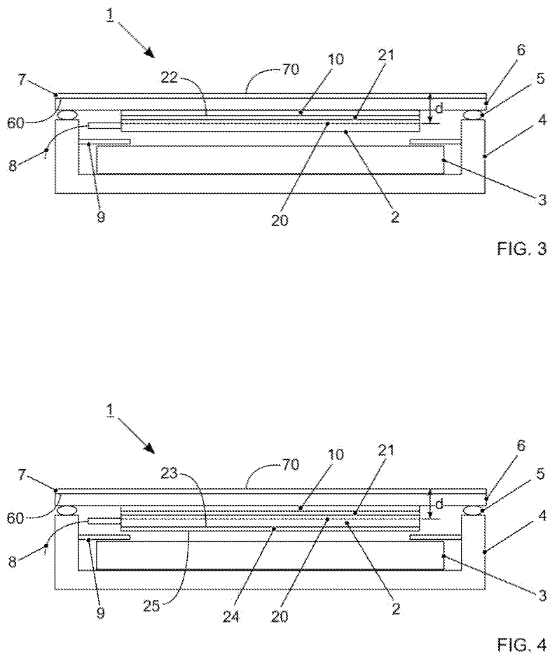

FIG. 3 schematically shows a second embodiment of a display element 1 according to the disclosure. It largely corresponds to the display element 1 shown in FIG. 2; however, the display panel 2 in this exemplary embodiment is connected to the surface shield 6 by an optical bonding layer 10. The optical bonding layer 10 has a thickness of less than 0.5 mm, preferably less than 0.4 mm. The use of a very thin bonding layer 10 having a defined thickness allows further reduction of the distance between the light exit from the display panel 2 and the surface 70 of the decoration 7. At the same time, the stability of the overall construction is increased and a constant distance between the surface 22 of the display panel 2 and the surface shield 6 is attained. For the bonding layer 10, for example, an optical clear adhesive film or a layer of a liquid optical clear adhesive can be used. Deviations from the planarity of the bonding layer should preferably not exceed ±0.1 mm.

FIG. 4 schematically shows a third embodiment of a display element 1 according to the disclosure. It largely corresponds to the display element 1 shown in FIG. 3; however, a transparent glass 24 is laminated onto an underside 23 of the display panel 2. This allows an increase in the stiffness of the overall system. This is advantageous particularly if a thickness of the upper cover glass 21 of the display panel 2 was reduced before the connection of the display panel 2 to the surface shield 6, for example by the use of slimming technologies. In order to obtain maximum stiffness, the transparent glass 24 can be larger than the display panel 2 and may optionally also be connected to the housing 4 or a wide element for stabilization. On account of the lamination of the additional transparent glass 24, it is expedient to provide a hard coat polarizer 25 on the underside of the transparent glass 24.

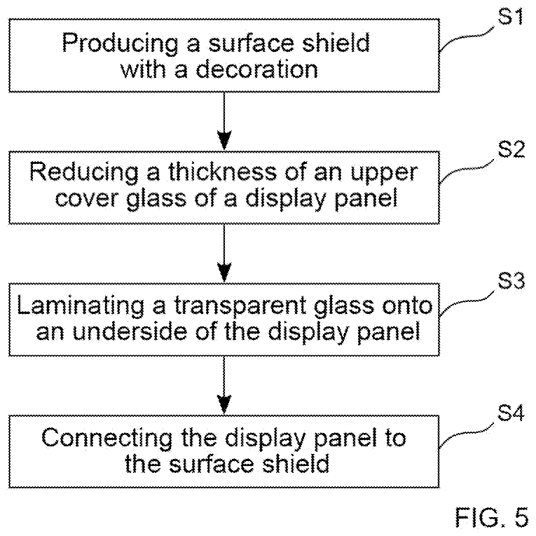

FIG. 5 schematically shows a method for producing a display element according to the disclosure. In a first step, a surface shield with a decoration arranged on a top side of the surface shield is produced S1. Optionally, a thickness of an upper cover glass of the display panel may be reduced S2, e.g. using slimming technologies. In addition, a transparent glass may be laminated S3 onto an underside of the display panel. The display panel is then connected S4 to the surface shield by an optical bonding layer. In this case, the optical bonding layer has a thickness of less than 0.5 mm, preferably less than 0.4 mm.

1. A display element comprising:
a display panel;
a backlight arranged behind the display panel;
a surface shield; and
a decoration arranged on a top side of the surface shield;
wherein a distance between light valves of the display panel and a surface of the decoration is less than 3 mm, preferably less than 2 mm.

2. The display element as claimed in claim 1, wherein a thickness of the surface shield in a display region located above the display panel is thinner than in a peripheral region extending around the display panel.

3. The display element as claimed in claim 1, wherein the display panel is connected to the surface shield by an optical bonding layer having a thickness of less than 0.5 mm.

4. The display element as claimed in claim 1, wherein a transmission of the decoration is less than 30% and/or a modulation transfer function of the decoration is greater than 0.5.

5. The display element as claimed in claim 1, wherein a resolution of the display panel is greater than 150 ppi.

6. The display element as claimed in claim 1, wherein a luminance of the backlight is greater than 2500 cd/m².

7. The display element as claimed in claim 1, wherein the backlight is locally controllable.

8. The display element as claimed in claim 1, wherein the display panel has in-cell touch sensors.

9. A method for producing a display element, the method comprising:
producing a surface shield with a decoration arranged on a top side of the surface shield; and
connecting a display panel to the surface shield by an optical bonding layer having a thickness of less than 0.5 mm.

10. The method as claimed in claim 9, wherein a thickness of an upper cover glass of the display panel is reduced before the process of connecting the display panel to the surface shield.

11. The method as claimed in claim 10, wherein a transparent glass is laminated onto an underside of the display panel.
